(19) United States
(12) Patent Application Publication
(10) Pub. No.: US 2004/0191670 A1
(43) Pub. Date: Sep. 30, 2004

(54) Chemical amplification type positive resist composition

(75) Inventors: Nobuo Ando, Toyonaka-shi (JP); Hiroshi Moriuma, Toyonaka-shi (JP); Kaoru Araki, Kyoto-shi (JP); Masumi Suetsugu, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/687,611

(22) Filed: Oct. 20, 2003

(30) Foreign Application Priority Data
Oct. 23, 2002 (JP) 2002-308103
Apr. 16, 2003 (JP) 2003-111280

(51) Int. Cl. G03C 1/76

(52) U.S. Cl. 430/270.1

(57) ABSTRACT

The present invention provides a chemical amplification type positive resist composition comprising resin which itself is insoluble or poorly soluble in an alkali aqueous solution but becomes soluble in an alkali aqueous solution by the action of an acid, an acid generator and a compound having an aromatic ring, having a molecular weight of 1000 or less and showing light absorption of a 1000 liter/(mol*cm) or more in terms of molar extinction coefficient in a wavelength range from 190 nm to 260 nm, wherein the ratio of said compound is 0.01 to 20% by weight based on the resin.

### BACKGROUND OF THE INVENTION

1. Field of the Invention

The present invention relates to a chemical amplification type resist composition for use in microfabrication of semiconductor.

2. Related Art

Semiconductor microfabrication employs a lithography process using a resist composition. In lithography, theoretically, the shorter the exposure wavelength becomes, the higher the resolution can be made, as expressed by Rayleigh's diffraction limit formula. The wavelength of an exposure light source for lithography used in the manufacture of semiconductor devices has been shortened year by year as g line having a wavelength of 436 nm, i line having a wavelength of 365 nm and KrF excimer laser having a wavelength of 248 nm. ArF excimer laser having a wavelength of 193 nm seems to be promising as the next-generation exposure light source.

Since a lens used in excimer laser exposure machine has a shorter life compared with the life of those used in conventional exposure light sources, it is desirable that the time period of exposure to excimer laser light is as short as possible. As the sensitivity of a resist is required to be enhanced for the purpose above, so-called chemical amplifying type resist utilizing a catalytic action of an acid generated by exposure, and containing a resin having a group that is cleaved by the action of the acid is used.

There are, recently, progressing applications of KrF and ArF resists to a high reflective substrate such as decrease in the thickness of a resist film, an ion injection process and the like, and there is an increasing influence exerted on resist abilities of standing wave effect, particularly, variation in form and line width.

However, conventionally known chemical amplification type resist compositions generate a phenomenon of waving of a resist side wall by the influence of a standing wave or a phenomenon of line edge roughness, namely decrease in smoothness of pattern side walls, causing a problem of deterioration in uniformity of line width. Regarding this, conventionally, there are technologies using a reflection preventing film for suppressing the influence of reflection light from a substrate (for example, JP11-511194-A).

### SUMMARY OF THE INVENTION

An object of the present invention is to provide a chemical amplification type positive resist composition suitable for KrF, ArF excimer laser lithography and the like, excellent in various resist abilities such as sensitivity, resolution and the like, and diminishing decrease in smoothness of pattern wall surfaces due to standing wave effect, generated in application to a high reflective substrate or generated by decreasing the thickness of a resist film.

The present invention relates to the followings:

<1> A chemical amplification type positive resist composition comprising resin which itself is insoluble or poorly soluble in an alkali aqueous solution but becomes soluble in an alkali aqueous solution by the action of an acid, an acid generator and a compound having an aromatic ring, having a molecular weight of 1000 or less and showing light absorption of a 1000 liter/(mol*cm) or more in terms of molar extinction coefficient in a wavelength range from 190 nm to 260 nm, wherein the ratio of said compound is 0.01 to 20% by weight based on the resin.

<2> The composition according to <1> wherein said compound is the one showing light absorption of a 1000 liter/(mol*cm) or more in terms of molar extinction coefficient in a wavelength range from 190 nm to 200 nm.

<3> The composition according to <1> wherein said compound is the one showing light absorption of a 1000 liter/(mol*cm) or more in terms of molar extinction coefficient in a wavelength range from 240 nm to 260 nm.

<4> The composition according to any one of <1>to <3> wherein said compound is at least one compound selected from the group consisting of a compound of the formula (I)

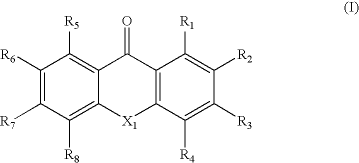

wherein R₁, R₂, R₃, R₄, R₅, R₆, R₇ and R₈ each independently represent hydrogen, alkyl, alkoxy or hydroxyl, X₁ represents sulfur, oxygen or CH₂ and a compound of the formula (II)

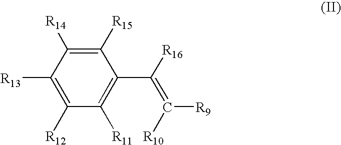

wherein R₉, R₁₀, R₁₁, R₁₂, R₁₃, R₁₄, R₁₅ and R₁₆ each independently represent hydrogen, alkyl, alkoxy, carboxylate group, cyano, amino, phenyl, carboxyl, benzoyl, hydroxyl or halogen, and at least one CH in the alkyl or alkoxy may be substituted by nitrogen.

<5> The composition according to <4>wherein R₁ to R₈ each independently represent hydrogen, alkyl having 1 to 8 carbon atoms or alkoxy having 1 to 8 carbon atoms and X₁ represents sulfur or oxygen.

<6> The composition according to <4>wherein R₉, R₁₀ and R₁₆ each independently represent hydrogen, cyano or carboxylate having 2 to 9 carbon atoms.

<7> The composition according to <6>wherein carboxylate having 2 to 9 carbon atoms is alkyloxycarbonyl having 2 to 9 carbon atoms.

<8> The composition according to any one of <1>to <7>which further comprises organic base compound as a quencher.

### DESCRIPTION OF PREFERRED EMBODIMENTS

The composition of the present invention contains a compound having an aromatic ring, having a molecular weight of 1000 or less and showing light absorption of 1000 liter/(mol*cm) or more in terms of a molar extinction coefficient in a wavelength range from 190 nm to 260 nm, and preferably of 5000 liter/(mol*cm) or more (hereinafter referred to as “the aromatic ring compound”).

Preferred examples of the aromatic ring compound include a compound represented by the following formulae (I) or (II) and showing light absorption of 1000 liter/(mol*cm) or more in terms of a molar extinction coefficient in a wavelength range from 190 nm to 260 nm.

The formula (I)

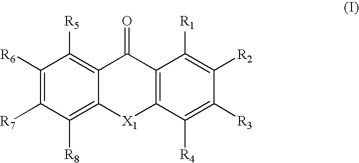

In the formula (I) above, R₁, R₂, R₃, R₄, R₅, R₆, R₇ and R₈ each independently represent hydrogen, alkyl, alkoxy or hydroxyl, X₁ represents sulfur, oxygen or CH₂.

The formula (II)

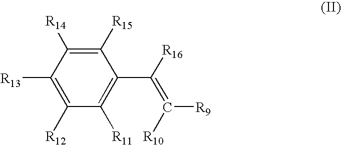

In the formula (II) above, R₉, R₁₀, R₁₁, R₁₂, R₁₃, R₁₄, R₁₅ and R₁₆ each independently represent hydrogen, alkyl, alkoxy, carboxylate group, cyano, amino, phenyl, carboxyl, benzoyl, hydroxyl or halogen, and at least one CH in the alkyl or alkoxy may be substituted by nitrogen.

In the formula (I), the alkyl in R₁ to R₈ preferably has 1 to 8 carbon atoms, and the alkyl may be branched. Examples thereof include methyl, ethyl, propyl, isopropyl, butyl, isobutyl, sec-butyl, tert-butyl, pentyl, isopentyl, sec-pentyl, neopentyl, tert-pentyl, 3-pentyl, hexyl, neohexyl, sec-hexyl, heptyl, isoheptyl, neoheptyl, sec-heptyl, octyl, isooctyl, tert-octyl, and the like. The alkoxy in R₁ to R₈ preferably has 1 to 8 carbon atoms, and the alkoxy may be branched. Examples thereof include methoxy, ethoxy, propoxy, isopropoxy, butoxy, isobutoxy, sec-butoxy, tert-butoxy, pentoxy, isopentoxy, sec-pentoxy, neopentoxy, tert-pentoxy, 3-pentoxy, hexyloxy, neohexyloxy, sec-hexyloxy, heptyloxy, isoheptyloxy, neoheptyloxy, sec-heptyloxy, octyloxy, isooctyloxy, tert-octyloxy, and the like.

In the formula (I), sulfur and oxygen are preferred for X₁, and hydrogen, alkyl having 1 to 8 carbon atoms and alkoxy having 1 to 8 carbon atoms are preferred for R₁ to R₈.

In the compound of the formula (I), when the two or more stereoisomers based on cis/trans formation of carbon-carbon double bond can exist, either one or mixture of them may be used for the present invention.

In the formula (II), the alkyl in R₉ to R₁₆ preferably has 1 to 8 carbon atoms, and the alkyl may be branched, further at least one CH in the alkyl may be substituted by nitrogen. Examples thereof include methyl, ethyl, propyl, isopropyl, butyl, isobutyl, sec-butyl, tert-butyl, pentyl, isopentyl, sec-pentyl, neopentyl, tert-pentyl, 3-pentyl, methylamino, dimethylamino, methylethylamino, diethylamino, aminomethyl, aminoethyl, and the like.

The alkoxy in R₉ to R₁₆ preferably has 1 to 8 carbon atoms, and the alkoxy may be branched, further at least one CH in the alkoxy may be substituted by nitrogen. Examples thereof include methoxy, ethoxy, propoxy, isopropoxy, butoxy, isobutoxy, sec-butoxy, tert-butoxy, pentoxy, isopentoxy, sec-pentoxy, neopentoxy, tert-pentoxy, 3-pentoxy, aminomethoxy, N-methylaminomethoxy, N,N-dimethylaminomethoxy, and the like. The carboxylate(—COOR) in R₉ to R₁₆ preferably has 2 to 9 carbon atoms. Examples of carboxylate(—COOR) include alkoxycarbonyl, alkenyloxycarbonyl, cycloalkyloxycarbonyl. Specific examples of alkoxycarbonyl include methoxycarbonyl, ethoxycarbonyl, propoxycarbonyl, isopropoxycarbonyl, butoxycarbonyl, isobutoxycarbonyl, sec-butoxycarbonyl, tert-butoxycarbonyl, pentoxycarbonyl, neopentoxycarbonyl, tert-pentoxycarbonyl, isopentoxycarbonyl, sec-pentoxycarbonyl, tert-pentoxycarbonyl, and the like. Specific examples of alkenyloxycarbonyl include vinyloxycarbonyl, allyloxycarbonyl, 1-, 2- or 3-butenyloxycarbonyl, and the like, 1-, 2-, 3- or pentenyloxycarbonyl, and the like. Specific examples of cycloalkyloxycarbonyl include cyclopentyloxycarbonyl, cyclopropyloxycarbonyl, cyclobutyloxycarbonyl, cyclohexyloxycarbonyl, cycloheptyloxycarbonyl and the like.

Examples of the halogen in R₉ to R₁₆ include fluorine, chlorine, bromine, iodine, and the like.

In the formula (II), hydrogen, carboxylate having 2 to 9 carbon atoms and cyano are preferred for R₉, R₁₀ and R₁₆.

In the compound of the formula (II), when the two or more stereoisomers based on cis/trans formation of carbon-carbon double bond can exist, either one or mixture of them may be used for the present invention.

This compound can be used also as a mixture of two or more compounds. Typical examples of this compound include compounds of the following formulae.

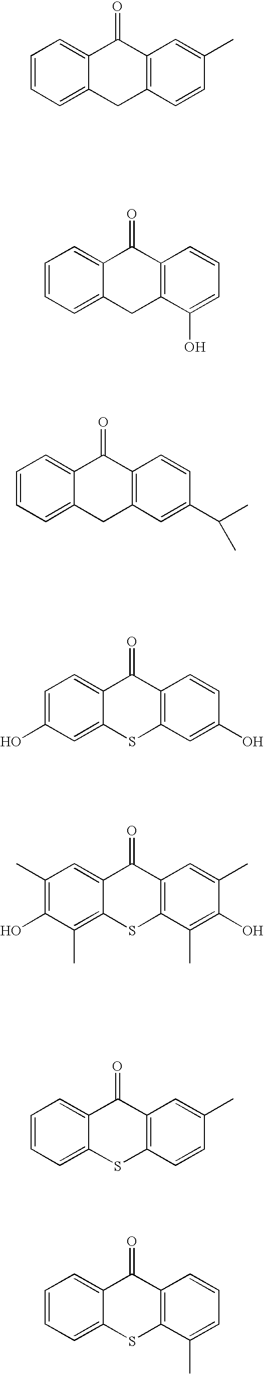

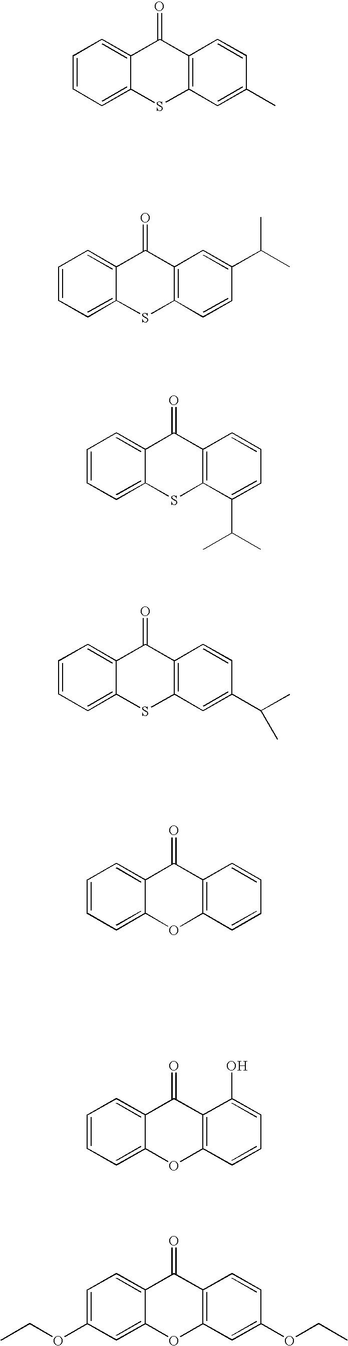

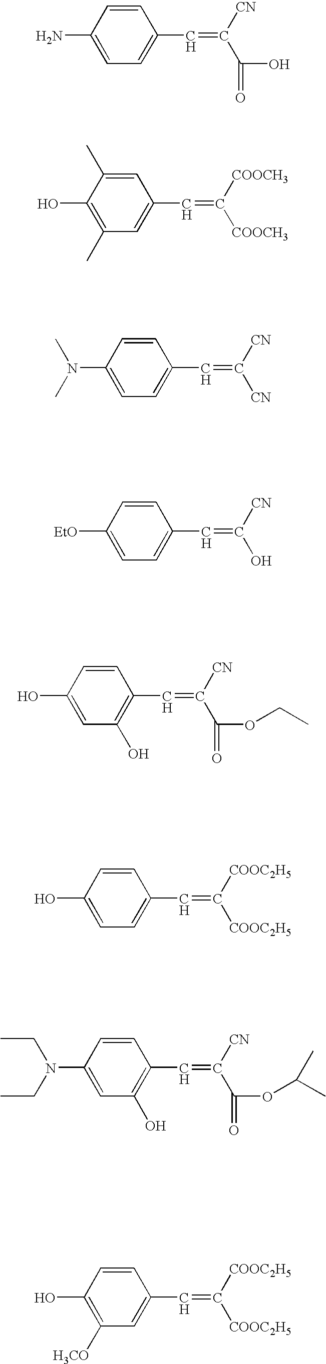

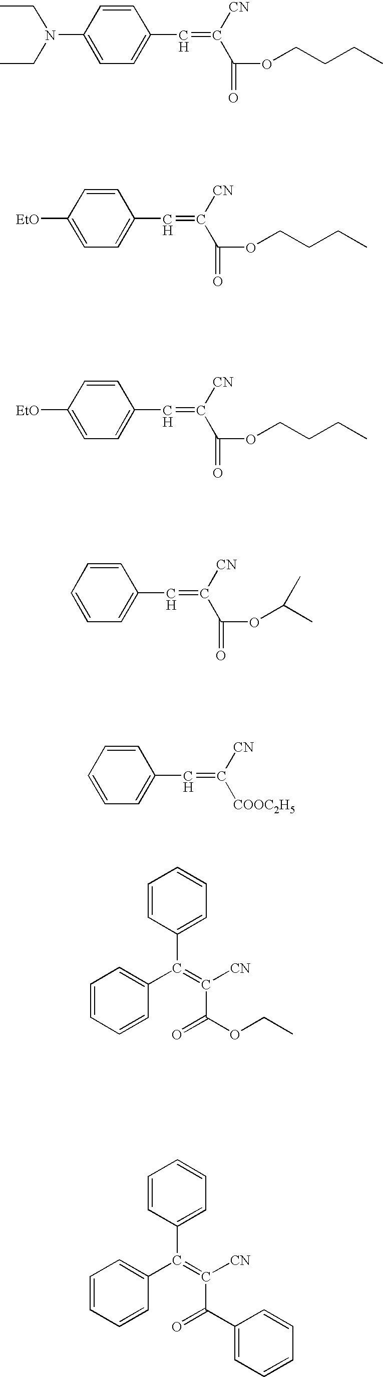

The chemical amplification type resist composition contains an acid generator generating an acid with the action of radiation, and utilizes a catalytic action of an acid generated from an acid generator at parts irradiated with radiation.

Specifically, an acid generated at parts irradiated with radiation is diffused by the following heat treatment (post exposure bake) and dissociates a protective group of a resin and the like, and resultantly solubilizes the parts irradiated with radiation in an alkali.

In the present invention, the resin which itself is insoluble or poorly soluble in an alkali aqueous solution but becomes soluble in an alkali aqueous solution by the action of an acid can be a resin having a protective group which can be dissociated with the action of an acid, insoluble or poorly soluble itself in an alkali aqueous solution but becomes soluble in an alkali aqueous solution after dissociation of the above-mentioned protective group by the action of an acid.

This resin can be, for example, one obtained by introducing a protective group dissociable by the action of an acid into an alkali-soluble resin.

As the alkali-soluble resin, are alkali-soluble resins having a phenol skeleton, alkali-soluble resins having a (meth)acrylate group and having an alicyclic ring and carboxyl group at the alcohol side of the ester, and the like. Specific examples thereof include polyvinylphenol resins, polyisopropenylphenol resins, resins obtained by partial alkyl-etherification of hydroxyl groups on these polyvinylphenol resins or polyisopropenylphenol resins, resins obtained from copolymerization of vinylphenol or isopropenylphenol with other polymerizable unsaturated compounds, resins which are polymers of alicyclic esters of (meth)acrylic acid and having a carboxyl group in its alicyclic ring, resins obtained from copolymerization of alicyclic esters of (meth)acrylic acid with (meth)acrylic acid, and the like.

Such groups having an ability of suppressing dissolution into an alkali aqueous solution but unstable to an acid can be known various protective groups. Examples thereof include tert-butyl, groups in which quaternary carbon is bonded to an oxygen atom such as tert-butoxycarbonyl, tert-butoxycarbonylmethyl, and the like; acetal type groups such as methoxymethyl, ethoxymethyl, 1-ethoxyethyl, 1-isobutoxyethyl, 1-isopropoxyethyl, 1-ethoxypropyl, tetrahydro-2-pyranyl, tetrahydro-2-furyl, 1-(2-methylpropoxy)ethyl, 1-(2-methoxyethoxy)ethyl, 1-(2-acetoxyethoxy)ethyl, 1-[2-(1-adamantyloxy)ethoxy]ethyl, 1-[2-(1-adamantanecarbonyloxy)ethoxy]ethyl, and the like; non-aromatic cyclic compounds such as isobornyl, 1-(1-adamantyl)-1-alkyl, 3-oxocyclohexyl, 4-methyltetrahydro-2-pyron-4-yl (derived from mevaloniclactone), 2-methyl-2-adamantyl, 2-ethyl-2-adamentyl; and the like.

These groups shall substitute for a hydrogen atom of a phenolic hydroxyl group or a hydrogen atom of a carboxyl group.

These groups can be introduced into an alkali-soluble resin having a phenolic hydroxyl group or carboxyl group by a known protective group introducing reaction. Further, the above-mentioned resin can be obtained also by copolymerization using as one monomer an unsaturated compound having such a group.

The acid generator in the composition of the present invention can be selected from various compounds generating an acid by irradiation with radiation on the substance itself or a resist composition containing the substance. For example, onium salts, halogenated alkyltriazine-based compounds, disulfone-based compounds, compounds having a diazomethanesulfonyl skeleton, sulfonate-based compounds and the like, are listed. As the onium salt, onium salts in which one or more nitro groups are contained in an anion, onium salts in which one or more ester groups are contained in an anion, and the like are listed.

diphenyliodonium trifluoromethanesulfonate,

4-methoxyphenylphenyliodinium hexafluoroantimonate,

4-methoxyphenylphenyliodinium trifluoromethanesulfonate,

bis(4-tert-butylphenyl)iodonium tetrafluoroborate

bis(4-tert-butylphenyl)iodonium hexafluorophosphate,

bis(4-tert-butylphenyl)iodonium hexafluoroantimonate

bis(4-tert-butylphenyl)iodonium trifluoromethanesulfonate,

triphenylsulfonium hexafluorophosphate,

triphenylsulfonium hexafluoroantimonate,

triphenylsulfonium trifluoromethanesulfonate,

p-tolyldiphenylsulfonium trifluoromethanesulfonate,

p-tolyldiphenylsulfonium perfluorobutanesulfonate,

p-tolyldiphenylsulfonium perfluorooctanesulfonate,

2,4,6-trimethylphenyldiphenylsulfonium trifluoromethanesulfonate,

4-tert-butylphenyldiphenylsulfonium trifluoromethanesulfonate,

4-phenylthiophenyldiphenylsulfonium hexafluorophosphate,

4-phenylthiophenyldiphenylsulfonium hexafluoroantimonate,

1-(2-naphtholylmethyl)thiolanium hexafluoroantimonate,

1-(2-naphtholylmethyl)thiolanium trifluoromethanesulfonate,

4-hydroxy-1-naphthyldimethylsulfonium hexafluoroantimonate,

4-hydroxy-1-naphthyldimethylsulfonium trifluoromethanesulfonate,

cyclohexylmethyl(2-oxocyclohexyl)sulfonium trifluoromethanesulfonate,

cyclohexylmethyl(2-oxocyclohexyl)sulfonium perfluorobutanesulfonate,

cyclohexylmethyl(2-oxycyclohexyl)sulfonium perfluorootcanesulfonate,

2-oxo-2-phenylethyltiacyclopentanium trifluoromethanesulfonate,

2-oxo-2-phenylethyltiacyclopentanium perfluorobutanesulfonate,

2-oxo-2-phenylethyltiacyclopentanium perfluorooctanesulfonate,

2-methyl-4,6-bis(trichloromethyl)-1,3,5-triazine,

2,4,6-tris(trichloromethyl)-1,3,5-triazine

2-phenyl-4,6-bis(trichloromethyl)-1,3,5-triazine,

2-(4-chlorophenyl)-4,6-bis(trichloromethyl)-1,3,5-triazine,

2-(4-methoxyphenyl)-4,6-bis(trichloromethyl)-1,3,5-triazine,

2-(4-methoxy-1-naphthyl)-4,6-bis(trichloromethyl)-1,3,5-triazine,

2-(benzo[d][1,3]dioxolan-5-yl)-4,6-bis(trichloromeythyl)-1,3,5-triazine,

2-(4-methoxystyryl)-4,6-bis(trichloromethyl)-1,3,5-triazine,

2-(3,4,5-trimethoxystyryl)-4,6-bis(trichloromethyl)-1,3,5-triazine,

2-(3,4-dimethoxystyryl)-4,6-bis(trichloromethyl)-1,3,5-triazine,

2-(2,4-dimethoxystyryl)-4,6-bis(trichloromethyl)-1,3,5-triazine,

2-(2-methoxystyryl)-4,6-bis(trichloromethyl)-1,3,5-triazine,

2-(4-butoxystyryl)-4,6-bis(trichloromethyl)-1,3,5-triazine,

2-(4-pentyloxystyryl)-4,6-bis(trichloromethyl)-1,3,5-triazine,

diphenyl disulfone,

di-p-tolyl disulfone

bis(phenylsulfonyl)diazomethane,

bis(4-chlorophenylsulfonyl)diazomethane,

bis(p-tolylsulfonyl)diazomethane,

bis(4-tert-butylphenylsulfonyl)diazomethane,

bis(2,4-xylylsulfonyl)diazomethane,

bis(cyclohexylsulfonyl)diazomethane,

(benzoyl)(phenylsulfonyl)diazomethane,

1-benzoyl-1-phenylmethyl p-toluenesulfonate (generally called “benzoin tosylate”),

2-benzoyl-2-hydroxy-2-phenylethyl p-toluenesulfonate (generally called α-methylolbenzoin tosylate),

1,2,3-benzene-tri-yl tris(methanesulfonate),

2,6-dinitrobenzyl p-toluenesulfonate,

2-nitrobenzyl p-toluenesulfonate,

4-nitrobenzyl p-toluenesulfonate,

N-(phenylsulfonyloxy)succinimide,

N-(trifluoromethylsulfonyloxy)succinimide,

N-(trifluoromethylsulfonyloxy)phthalimide,

N-(trifluoromethylsulfonyloxy)-5 -norbornene-2,3-dicarboxyimide,

N-(trifluoromethylsulfonyloxy)naphthalimide,

N-(10-camphorsulfonyloxy)naphthalimide and the like.

In the resist composition of the present invention, deterioration in abilities due to deactivation of an acid in leaving after exposure can be improved by adding an organic base compound as a quencher. The organic base compound is particularly preferably a nitrogen-containing basic organic compound. As specific examples of such a nitrogen-containing basic organic compound, amines of the following formulae are listed.

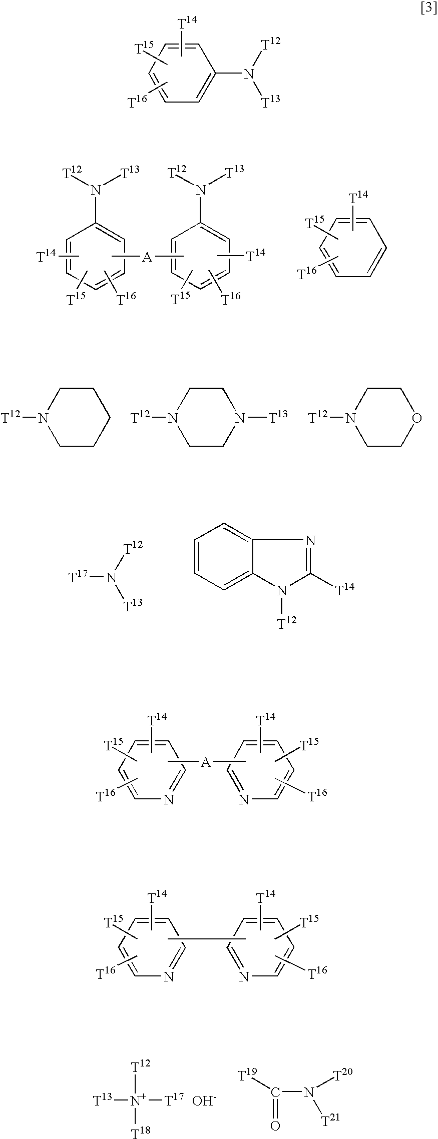

In the formulae, T¹² and T¹³ each independently represent hydrogen, alkyl, cycloalkyl or aryl. The alkyl preferably has about 1 to 6 carbon atoms, the cycloalkyl preferably has about 5 to 10 carbon atoms, and the aryl preferably has about 6 to 10 carbon atoms. Furthermore, at least one hydrogen on the alkyl, cycloalkyl or aryl may each independently be substituted with hydroxyl group, amino group, or alkoxy group having 1 to 6 carbon atoms. At least one hydrogen on the amino group each independently may be substituted with alkyl group having 1 to 4 carbon atoms.

T¹⁴, T¹⁵ and T¹⁶ each independently represent hydrogen, alkyl cycloalkyl, aryl or alkoxy. The alkyl preferably has about 1 to 6 carbon atoms, the cycloalkyl preferably has about 5 to 10 carbon atoms, the aryl preferably has about 6 to 10 carbon atoms, and the alkoxy preferably has about 1 to 6 carbon atoms. Furthermore, at least one hydrogen on the alkyl, cycloalkyl, aryl or alkoxy each independently may be substituted with hydroxyl group, amino group, or alkoxy group having 1 to 6 carbon atoms. At least one hydrogen on the amino group may be substituted with alkyl group having 1 to 4 carbon atoms.

T¹⁷ represents alkyl or cycloalkyl. The alkyl preferably has about 1 to 6 carbon atoms, and the cycloalkyl preferably has about 5 to 10 carbon atoms. Furthermore, at least one hydrogen on the alkyl or cycloalkyl may each independently be substituted with hydroxyl group, amino group, or alkoxy group having 1 to 6 carbon atoms. At least one hydrogen on the amino group may be substituted with alkyl group having 1 to 4 carbon atoms.

In the formulae, T¹⁸ represents alkyl, cycloalkyl or aryl. The alkyl preferably has about 1 to 6 carbon atoms, the cycloalkyl preferably has about 5 to 10 carbon atoms, and the aryl preferably has about 6 to 10 carbon atoms. Furthermore, at least one hydrogen on the alkyl, cycloalkyl or aryl may each independently be substituted with hydroxyl group, amino group, or alkoxy group having 1 to 6 carbon atoms. At least one hydrogen on the amino group each independently may be substituted with alkyl group having 1 to 4 carbon atoms.

However, none of T¹² and T¹³ in the compound represented by the above formula [3] is hydrogen.

A represents alkylene, carbonyl, imino, sulfide or disulfide. The alkylene preferably has about 2 to 6 carbon atoms.

Moreover, among T¹²-T¹⁸, in regard to those which can be straight-chained or branched, either of these may be permitted.

T¹⁹, T²⁰ and T²¹ each independently represent hydrogen, alkyl having 1 to 6 carbon atoms, aminoalkyl having 1 to 6 carbon atoms, hydroxyalkyl having 1 to 6 carbon atoms or substituted or unsubstituted aryl having 6 to 20 carbon atoms, or T¹⁹ and T²⁰ bond to form alkylene which forms a lactam ring together with adjacent CO—N—.

Examples of such compounds include hexylamine, heptylamine, octylamine, nonylamine, decylamine, aniline, 2-, 3- or 4-methylaniline, 4-nitroaniline, 1- or 2-naphtylamine, ethylenediamine, tetramethylenediamine, hexamethylenediamine, 4,4′-diamino-1,2-diphenylethane, 4,4′-diamino-3,3′-dimethyldiphenylmethane, 4,4′-diamino-3,3′-diethyldiphenylmethane, dibutylamine, dipentylamine, dihexylamine, diheptylamine, dioctylamine, dinonylamine, didecylamine, N-methylaniline, piperidine, diphenylamine, triethylamine, trimethylamine, tripropylamine, tributylamine, tripentylamine, trihexylamine, triheptylamine, trioctylamine, trinonylamine, tridecylamine, methyldibutylamine, methyldipentylamine, methyldihexylamine, methyldicyclohexylamine, methyldiheptylamine, methyldioctylamine, methyldinonylamine, methyldidecylamine, ethyldibutylamine, ethydipentylamine, ethyldihexylamine, ethydiheptylaamine, ethyldioctylamine, ethyldinonylamine, ethyldidecylamine, dicyclohexylmethylamine, tris[2-(2-methoxyethoxy)ethyl] amine, triisopropanolamine, N,N-dimethylaniline, 2,6-isopropylaniline, imidazole, pyridine, 4-methylpyridine, 4-methyimidazole, bipyridine, 2,2′-dipyridylamine, di-2-pyridyl ketone, 1,2-di(2-pyridyl)ethane, 1,2-di(4-pyridyl)ethane, 1,3-di(4-pyridyl)propane, 1,2-bis(2-pyridyl)ethylene, 1,2-bis(4-pyridyl)ethylene, 1,2-bis(2-pyridyloxy)ethane, 4,4′-dipyridyl sulfide, 4,4′-dipyridyl disulfide, 1,2-bis(4-pyridyl)ethylene, 2,2′-dipicolylamine, 3,3′-dipicolylamine, tetramethylammonium hydroxide, tetraisopropylammonium hydroxide, tetrabutylammonium hydroxide, tetra-n-hexylammonium hydroxide, tetra-n-octylammonium hydroxide, phenyltrimethylammonium hydroxide, 3-trifluoromethylphenyltrimethylammonium hydroxide, (2-hydroxyethyl)trimethylammonium hydroxide (so-called “choline”), N-methylpyrrolidone, dimethylimidazole, and the like.

Furthermore, hindered amine compounds having piperidine skeleton as disclosed in JP-A-H11-52575 can be used as quencher.

It is preferable that the resist composition of the present invention contains the acid generator in an amount of 0.01 to 2% by weight based on the weight of the resin.

In the case where the organic basic compound as a quencher is contained, it is preferable that the resist composition of the present composition contains in an amount of 0.001 to 2% by weight, more preferably 0.01 to 1% by weight based on the weight of the resin.

The present composition can contain, if necessary, various additives in small amount such as a sensitizer, solution suppressing agent, other resins, surfactant, stabilizer, dye and the like, as long as the effect of the present invention is not prevented.

The present composition is usually in the form of a resist liquid composition in which the aforementioned ingredients are dissolved in a solvent, and the resist liquid composition is to be applied onto a substrate such as a silicon wafer by a conventional process such as spin coating. The solvent used here is sufficient to dissolve the aforementioned ingredients, have an adequate drying rate, and give a uniform and smooth coat after evaporation of the solvent and, hence, solvents generally used in the art can be used. In the present invention, the total solid content means total content exclusive of solvents.

Examples thereof include glycol ether esters such as ethylcellosolve acetate, methylcellosolve acetate and propylene glycol monomethyl ether acetate; esters such as ethyl lactate, butyl lactate, amyl lactate and ethyl pyruvate and the like; ketones such as acetone, methyl isobutyl ketone, 2-heptanone and cyclohexanone; cyclic esters such as γ-butyrolactone, and the like. These solvents can be used each alone or in combination of two or more.

A resist film applied onto the substrate and then dried is subjected to exposure for patterning, then heat-treated for facilitating a deblocking reaction, and thereafter developed with an alkali developer. The alkali developer used here may be any one of various alkaline aqueous solutions used in the art, and generally, an aqueous solution of tetramethylammonium hydroxide or (2-hydroxyethyl)trimethylammonium hydroxide (commonly known as “choline”) is often used.

In the above descriptions, embodiments of the present invention have been explained, however, the embodiments of the present invention disclosed above are just examples and the scope of the present invention is not limited to these embodiments. The scope of the invention is shown by the claims, and further, includes all variations within meanings and ranges equivalent to the claims.

The following examples will illustrate the present invention further specifically, but the scope of the invention is not limited to these examples at all. In the examples, parts representing use amount are by weight unless otherwise stated. The weight-average molecular weight is a value measured by gel permeation chromatography using polystyrene as a standard.

### RESIN SYNTHESIS EXAMPLE 1

### (Synthesis of resin A1)

2-Ethyl-2-adamantyl methacrylate, 3-hydroxy-1-adamantyl methacrylate and α-methacryloyloxy-γ-butyrolactone were charged at a molar ratio of 5:2.5:2.5 (20.0 parts:9.5 parts:7.3 parts), and methyl isobutyl ketone in twice weight based on all monomers was added, to prepare solution. To the solution was added azobisisobutyronitrile as an initiator in a ratio of 2 mol % based on all monomer molar amount, and the mixture was heated at 80° C. for about 8 hours. Then, the reaction solution was poured into large amount of heptane to cause precipitation, and this operation was repeated three times for purification. As a result, copolymer having a weight-average molecular weight of about 9,200 was obtained. This copolymer has units of the following formulae, and called resin 1.

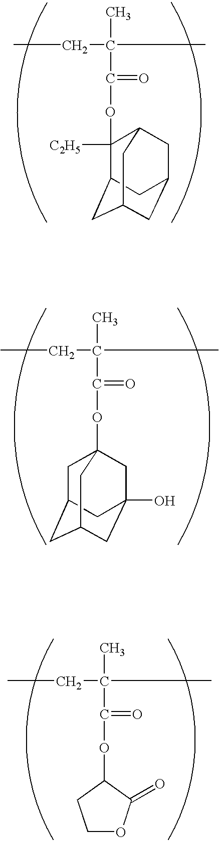

### RESIN SYNTHESIS EXAMPLE 2

### (Synthesis of 2-ethyl-2-adamantyl methacrylate/p-acetoxystyrene copolymer (20:80))

Into a flask was charged 39.7 g (0.16 mol) of 2-ethyl-2-adamantyl methacrylate, 103.8 g (0.64 mol) of p-acetoxystyrene and 265 g of isopropanol, and the mixture was heated up to 75° C. under a nitrogen atmosphere. Into this solution was dropped a solution of 11.05 g (0.048 mol) of dimethyl 2,2′-azobis(2-methylpropionate) in 22.11 g of isopropanol. The mixture was stirred at 75° C. for about 0.3 hours and under reflux for about 12 hours, then, diluted with acetone, and the reaction liquid was poured into a large amount of methanol to precipitate polymer which was then filtrated.

The yield of the resulted copolymer of 2-ethyl-2-adamantyl methacrylate and p-acetoxystyrene was 250 g (weight of wet cake including methanol).

### RESIN SYNTHESIS EXAMPLE 3

### (Synthesis of 2-ethyl-2-adamantyl methacrylate/p-hydroxystyrene copolymer (20:80), resin A2)

Into a flask was charged 250 g of a copolymer of 2-ethyl-2-adamantyl methacrylate and p-acetoxystyrene (20:80), 10.3 g (0.084 mol) of 4-dimethylaminopyridine and 202 g of methanol, and the mixture was stirred under reflux for 20 hours. After cooling, the reaction liquid was neutralized with 7.6 g (0.126 mol) of glacial acetic acid, and a large amount of water was poured to cause precipitation. An operation of filtration of the deposited polymer, dissolution thereof into acetone and pouring a large amount of water to cause precipitation was repeated three times in total, for purification.

The weight of the obtained copolymer of 2-ethyl-2-adamantyl methacrylate and p-hydroxystyrene was 95.9 g. The weight-average molecular weight was about 8600, the degree of dispersion was 1.65 (GPC method: reduced by polystyrene), and the copolymerization ration was measured to be about 20:80 by a nuclear magnetic resonance (¹³C-NMR) spectrometer. This resin is called resin A2.

Next, in addition to the resins obtained in the above-mentioned resin synthesis examples, the following raw materials were used to prepare resist composition which was evaluated.

<Acid Generator>

B1: tris(4-tert-butylphenyl)sulfonium trifluoromethanesulfonate

B2: 4-methyldiphenylsulfonium trifluoromethanesulfonate

B3: triphenylsulfonium triisopropylbenzenesulfonate

B4: bis(tert-butylsulfonyl)diazomethane

<Quencher>

C1: 2,6-diisopropylaniline

<Compound having an aromatic ring and showing light absorption in a range from 190 to 260 nm >

D1: Mixture of the following compounds, molecular weight: 254 Molar extinction coefficient at a wavelength of 200 nm =23000 liter/(mol*cm)

Molar extinction coefficient at a wavelength of 250 nm =35600 liter/(mol*cm)

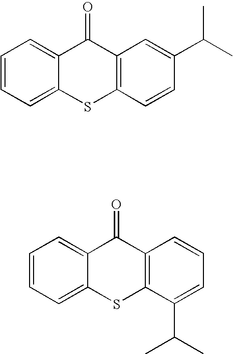

D2: Following compound, molecular weight: 294

Molar extinction coefficient at a wavelength of 200 nm=12000 liter/(mol*cm)

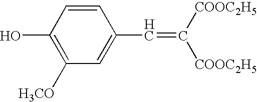

D3: Synthesis was conducted as follows.

### COMPOUND SYNTHESIS EXAMPLE 1

### (SYNTHESIS OF COMPOUND D3)

(1a) Synthesis of copolymer of 2-ethyl-2-adamantyl methacrylate and p-acetoxystyrene (30:70)

Into a flask was charged 59.6 g (0.24 mol) of 2-ethyl-2-adamantyl methacrylate, 90.8 g (0.56 mol) of p-acetoxystyrene and 279 g of isopropanol and the atmosphere was purged with nitrogen, and the mixture was heated to 75° C. Into this solution was dropped 11.05 g (0.048 mol) of dimethyl 2,2′-azobis(2-methylpropionate) dissolved in 22.11 g of isopropanol. The mixture was stirred at 75° C. for about 0.3 hours and under reflux for about 12 hours, then, diluted with acetone, charged into methanol to cause crystallization, and the crystal was removed out by filtration. The weight of the obtained crude crystal of the copolymer of 2-ethyl-2-adamantyl methacrylate and p-acetoxystyrene was 250 g.

(1b) Synthesis of copolymer of 2-ethyl-2-adamantyl methacrylate and p-hydroxystyrene (30:70)

Into a flask was charged 250 g of the crude crystal of the copolymer of 2-ethyl-2-adamantyl methacrylate and p-acetoxystyrene (30:70) obtained in (1a), 10.8 g (0.088 mol) of 4-dimethylaminopyridine and 239 g of methanol, and the mixture was stirred under reflux for 20 hours. After cooling, the mixture was neutralized with 8.0 g (0.133 mol) of glacial acetic acid, charged into water to cause crystallization, and the crystal was removed out by filtration. Then, the crystal was dissolved in acetone, charged into water to cause crystallization, and the crystal was removed out by filtration, and this operation was repeated three times in total, then, the resulted-crystal was dried. The weight of the obtained crystal of the copolymer of 2-ethyl-2-adamantyl methacrylate and p-hydroxystyrene was 102.8 g. The weight-average molecular weight was about 8200, the degree of dispersion was 1.68 (GPC method: in terms of polystyrene), and the copolymerization ration was measured to be about 30:70 by a nuclear magnetic resonance (¹³C-NMR) spectrometer. This resin is called resin D3.

<Solvent>

E1:

Propylene glycol monomethyl ether acetate: 104.5 parts γ-butyrolactone: 5.5 parts

E2:

Propylene glycol monomethyl ether acetate: 130 parts

### EXAMPLES 1 TO 6 AND COMPARATIVE EXAMPLES 1 TO 3

The following components were mixed to give a solution which was further filtrated through a fluorine resin filter having a pore diameter of 0.2 μm, to prepare resist liquid.

Resin (kind and amount are described in Table 1)

Acid generator (kind and amount are described in Table 1)

Quencher (kind and amount are described in Table 1)

Additive (kind and amount are described in Table 1)

Solvent (kind and amount are described in Table 1)

On a silicon wafer, the above-mentioned resist liquid was spin-coated to give a film thickness after drying of 0.185 μm. After application of the resist liquid, the resist liquid was pre-baked on a direct hot plate at a temperature shown in the column of “PB” in Table 1 for 60 seconds. Each wafer on which the resist film had been thus formed was exposed to a line and space pattern while gradually changing the exposure amount using a ArF excimer stepper [“NSR ArF” manufactured by Nikon Corp., NA=0.55, ring band illumination (σout=0.75, σin=0.50)]. After exposure, post exposure bake was conducted for 60 seconds at a temperature shown in the column of “PEB” in Table 1 on a hot plate, further, paddle development was conducted with a 2.38 wt % tetramethylammonium hydroxide aqueous solution for 60 seconds.

A bright field pattern after development on an organic reflection preventing film substrate was observed by a scanning electron microscope, and the result is shown in Table 2.

The term “bright field pattern”, as used herein, means a pattern obtained by exposure and development through a reticle comprising an outer frame made of a chromium layer (light-shielding layer) and linear chromium layers (light-shielding layers) formed on a glass surface (light-transmitting portion) extending inside the outer frame. Thus, the bright field pattern is such that, after exposure and development, resist layer surrounding the line and space pattern is removed while resist layer corresponding to the outer frame is left on the outer side of the region from which the resist layer is removed.

The above-mentioned resist liquid was spin-coated to give a film thickness after drying of 0.185 g μm on a quartz wafer. After application of the resist liquid, pre-bake was conducted for 60 seconds at a temperature shown in the column of “PB” in Table 1 on a direct hot plate. The transmittance of each wafer on which a resist film had been thus formed was measured using a spectrophotometer [“DU-640” manufactured by Beckmann, quartz wafer was used as a blank].

Further, the compound was dissolved in CH₃CN, and the molar extinction coefficient was measured by a spectrophotometer [U-3500 type manufactured by Hitachi, Ltd.] using a quartz cell having an optical path of 1 cm.

The molar extinction coefficient was calculated by dividing the absorbency measured by the spectrophotometer (unit: 1/cm) by the mole concentration (unit: Mol/liter). The unit of molar extinction coefficient is liter/(mol*cm).

Effective sensitivity: It is expressed as the amount of exposure that the line pattern (light-shielding layer) and the space pattern (light-transmitting layer) become 1:1 after exposure through 0.14 μm line and space pattern mask and development.

Resolution: It is expressed as the minimum size of space pattern which gave the space pattern split by the line pattern at the exposure amount of the effective sensitivity.

Smoothness of pattern wall surface: Wall surfaces of dense line and space patterns (line:space=1:1) and isolated slit patterns were observed by a scanning electron microscope, and that when smoother than in Comparative Example 1, judged is ∘, and when there is no change, judge is X.

Transmittance: Transmittance of a film applied at a film thickness of 0.185 μg m on a quartz wafer, against light of 193 nm.

TABLE 1

| | | AG*¹ | QU*² | | | | |
|---|---|---|---|---|---|---|---|
| Example No. | Resin (parts) | (parts) | (parts) | CA*³ (parts) | SO*⁴ | PB | PEB |
| Example 1 | A1 | B1 | C1 | D1 | E1 | 100° C. | 120° C. |
| | (10) | (0.55) | (0.06) | (0.3) | | | |
| Example 2 | A1 | B1 | C1 | D1 | E1 | 115° C. | 120° C. |
| | (10) | (0.55) | (0.06) | (0.3) | | | |
| Example 3 | A1 | B1 | C1 | D1 | E1 | 115° C. | 120° C. |
| | (10) | (0.55) | (0.03) | (0.4) | | | |
| Example 4 | A1 | B2 | C1 | D1 | E1 | 115° C. | 120° C. |
| | (10) | (0.40) | (0.03) | (0.2) | | | |
| Example 5 | A1 | B1 | C1 | D2 | E1 | 100° C. | 120° C. |
| | (10) | (0.55) | (0.06) | (0.3) | | | |
| Example 6 | A1 | B1 | C1 | D2 | E1 | 115° C. | 120° C. |
| | (10) | (0.55) | (0.06) | (0.3) | | | |
| Comparative | A1 | B1 | C1 | — | E1 | 115° C. | 120° C. |
| Example 1 | (10) | (0.55) | (0.03) | | | | |
| Comparative | A1 | B2 | C1 | D3 | E1 | 115° C. | 120° C. |
| Example 2 | (10) | (0.40) | (0.03) | (0.2) | | | |
| Comparative | A1 | B2 | C1 | D3 | E1 | 115° C. | 120° C. |
| Example 3 | (10) | (0.40) | (0.03) | (0.5) | | | |

*¹(AG): Acid Generator
*²(QU): Quencher
*³(CA): Compound having an aromatic ring and showing light absorption in a range from 190 to 260 nm
*⁴(SO): Solvent

TABLE 2

| | Effective | | Smoothness | |
|---|---|---|---|---|
| | sensitivity | Resolution | of pattern | Transmittance |
| Example No. | (mJ/cm²) | (μm) | wall surface | (%) |
| Example 1 | 17.5 | 0.14 | ∘ | 54.8 |
| Example 2 | 18.5 | 0.14 | ∘ | 54.8 |
| Example 3 | 9.5 | 0.13 | ∘ | 52.5 |
| Example 4 | 6.0 | 0.13 | ∘ | 57.7 |
| Example 5 | 18.0 | 0.13 | ∘ | 61.4 |
| Example 6 | 18.0 | 0.13 | ∘ | 61.4 |
| Comparative | 7.5 | 0.13 | — | 66.6 |
| Example 1 | | | | |
| Comparative | 5.0 | 0.13 | x | 57.0 |
| Example 2 | | | | |
| Comparative | 5.5 | 0.14 | x | 46.9 |
| Example 3 | | | | |

### EXAMPLES 7, 8 AND COMPARATIVE EXAMPLE 4

The following components were mixed to give a solution which was further filtrated through a fluorine resin filter having a pore diameter of 0.2 μm, to prepare resist liquid.

Resin A2 4.3 parts/D3 5.7 parts

Acid generator B3 0.33 parts/B4 0.33 parts

Quencher C1 0.04 parts

Compound D1 amount is described in Table 3

Solvent E2 132 parts

On a silicon wafer, the above-mentioned resist liquid was spin-coated to give a film thickness after drying of 0.25 μm. After application of the resist liquid, the resist liquid was pre-baked on a direct hot plate at 110° C. for 60 seconds. Each wafer on which the resist film had been thus formed was exposed to a line and space pattern while gradually changing the exposure amount using a KrF excimer stepper [“NSR-2205EX12B” manufactured by Nikon Corp., NA=0.55, ring band illumination (σout=0.8, σin=0.53)]. After exposure, post exposure bake was conducted for 60 seconds at 120° C. on a hot plate, further, paddle development was conducted with a 2.38 wt % tetramethylammonium hydroxide aqueous solution for 60 seconds. A bright field pattern after development on an organic reflection preventing film substrate was observed by a scanning electron microscope, and the result is shown in Table 4.

The above-mentioned resist liquid was spin-coated to give a film thickness after drying of 0.28 μm on a quartz wafer. After application of the resist liquid, pre-bake was conducted for 60 seconds at 110° C. on a direct hot plate. The transmittance of each wafer on which a resist film had been thus formed was measured using a spectrophotometer [“DU-640” manufactured by Beckmann, quartz wafer was used as a blank].

The molar extinction coefficient was measured in the same manner as in Example 1.

Effective sensitivity: It is expressed as the amount of exposure that the line pattern (light-shielding layer) and the space pattern (light-transmitting layer) become 1:1 after exposure through 0.24pm line and space pattern mask and development.

Resolution: It was measured in the same manner as in Example 1

Smoothness of pattern wall surface: Wall surfaces of dense line and space patterns (line : space=1:1) and isolated slit patterns were observed by a scanning electron microscope, and that when smoother than in Comparative Example 4, judged is ∘, and when there is no change, judge is X.

Transmittance: Transmittance of a film applied at a film thickness of 0.25 μm on a quartz wafer, against light of 248 nm.

TABLE 3

| Example No. | Amount of D1 |
|---|---|
| Example 7 | 0.26 part |
| Example 8 | 0.50 part |
| Comparative | None |
| Example 4 | |

TABLE 4

| | Effective | | Smoothness | |
|---|---|---|---|---|
| | sensitivity | Resolution | of pattern | Transmittance |
| Example No. | (mJ/cm²) | (μm) | wall surface | (%) |
| Example 7 | 16.5 | 0.15 | ∘ | 74 |
| Example 8 | 18.0 | 0.15 | ∘ | 66 |
| Comparative | 13.5 | 0.15 | — | 86 |
| Example 4 | | | | |

The chemical amplification type positive resist composition of the present invention gives a resist pattern remarkably improving a phenomenon of waving of the resist side surface due to a standing wave effect and phenomenon of decrease in smoothness of the pattern side surface, which are problematical in reducing the thickness of a resist film or in application to a high reflection substrate, and also gives various excellent abilities such as dry etching durability, sensitivity, resolution and the like. Therefore, this composition is suitable for exposure using ArF or KrF excimer laser, and the like, and by this, a resist pattern of high abilities is obtained.

1. A chemical amplification type positive resist composition comprising resin which itself is insoluble or poorly soluble in an alkali aqueous solution but becomes soluble in an alkali aqueous solution by the action of an acid, an acid generator and a compound having an aromatic ring, having a molecular weight of 1000 or less and showing light absorption of a 1000 liter/(mol*cm) or more in terms of molar extinction coefficient in a wavelength range from 190 nm to 260 nm, wherein the ratio of said compound is 0.01 to 20% by weight based on the resin.

2. The composition according to claim 1 wherein said compound is the one showing light absorption of a 1000 liter/(mol*cm) or more in terms of molar extinction coefficient in a wavelength range from 190 nm to 200 nm.

3. The composition according to claim 1 wherein said compound is the one showing light absorption of a 1000 liter/(mol*cm) or more in terms of molar extinction coefficient in a wavelength range from 240 nm to 260 nm.

4. The composition according to claim 1 wherein said compound is at least one compound selected from the group consisting of a compound of the formula (I) 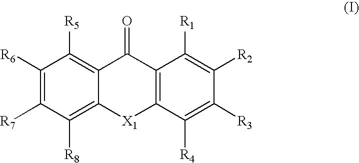
wherein R₁, R₂, R₃, R₄, R₅, R₆, R₇ and R₈ each independently represent hydrogen, alkyl, alkoxy or hydroxyl, X₁ represents sulfur, oxygen or CH₂ and a compound of the formula (II) 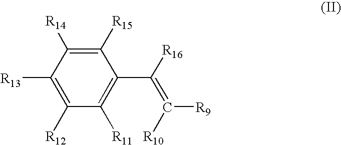
wherein R₉, R₁₀, R₁₁, R₁₂, R₁₃, R₁₄, R₁₅ and R₁₆ each independently represent hydrogen, alkyl, alkoxy, carboxylate group, cyano, amino, phenyl, carboxyl, benzoyl, hydroxyl or halogen, and at least one CH in the alkyl or alkoxy may be substituted by nitrogen.

5. The composition according to claim 4 wherein R₁ to R₈ each independently represent hydrogen, alkyl having 1 to 8 carbon atoms or alkoxy having 1 to 8 carbon atoms and X₁ represents sulfur or oxygen.

6. The composition according to claim 4 wherein R₉, R₁₀ and R₁₆ each independently represent hydrogen, cyano or carboxylate having 2 to 9 carbon atoms.

7. The composition according to claim 6 wherein carboxylate having 2 to 9 carbon atoms is alkyloxycarbonyl having 2 to 9 carbon atoms.

8. The composition according to claim 1 which further comprises organic base compound as a quencher.
